(19) United States
(12) Patent Application Publication
(10) Pub. No.: US 2012/0096683 A1
(43) Pub. Date: Apr. 26, 2012

(54) Decorative apparel and button assembly

(76) Inventor: Thomas Suriano, Myrtle Beach, SC (US)

(21) Appl. No.: 13/317,053

(22) Filed: Oct. 11, 2011

Related U.S. Application Data
(60) Provisional application No. 61/455,602, filed on Oct. 25, 2010.

(51) Int. Cl. A44B 1/28; G09F 3/00

(52) U.S. Cl. 24/105; 24/104; 40/315

(57) ABSTRACT

A two-piece button having a backing member and a front member, the front member and back member securable by a securing means extending through alignable apparel button holes to secure a piece of apparel, the front member of the two piece button capable of receiving a unique design and/or indicia on its front face.

### RELATED APPLICATIONS

Applicant claims the benefit of provisional application Ser. No. 61/455,602, filed Oct. 25, 2010.

### BACKGROUND OF THE INVENTION

1. Field of the Invention

The present invention relates to clothing and apparel, and more particularly to a two piece button accessory which allows the individual to stylize and personalize the clothing and apparel with unique and decorative two-piece buttons, which would replace the standard buttons normally found on shirts, pants and jackets.

2.Description of the Prior Art

Buttons are a traditional means of closure with respect to clothing and apparel. Golf shirts typically have two or three buttons at the front of the neck; dress shirts normally have buttons from the neck to the waist. Pants normally have a waist button and in some fashionable denims, the fly is also buttoned as opposed to zippered. Typically the buttons supplied by the manufacturer are colored to match the fabric so as not to draw attention to themselves and to cause the coloring of the fabric or the design of the fabric to stand out.

Many young people wish to make their own fashion statements with respect to the clothing that they wear and in the manner which they mix and match various designs. As yet, buttons have not been addressed with respect to making fashion statements in that the buttons on clothing and apparel are normally fixedly secured by the manufacturer and are accepted by the buyer and the wearer.

Applicant's unique two-piece button is designed to replace the fixedly secured buttons that normally are affixed to clothing and apparel and allow the wearer to choose buttons having a unique design which appeal to the wearer. These buttons can be mixed and matched and used to replace the buttons on shirts and slacks to allow the individual to display buttons having a unique design or indicia. The buttons will also permit the wearer to apply his own design or indicia to the button.

Applicant's unique two-piece button assembly would be utilized with a unique line of apparel in which the fixed buttons normally associated with apparel were absent and were replaced by a second alignable button hole. This would apply to the front of shirts, jackets, and the waist button on pants. Applicant's unique two-piece button would replace the fixedly secured buttons and allow the wearer to stylize the clothing to his or her taste.

### OBJECTS OF THE INVENTION

An object of the present invention is to provide for a novel line of apparel in which the normally affixed buttons are removed and replaced by an alignable second button hole, the aligned button holes designed to receive a unique two-piece button having its own design or indicia.

An object of the present invention is to provide for a novel two-piece button to replace standard fixed buttons on clothing and apparel, the unique two-piece button having its own design or indicia thereon.

A still further object of the present invention to provide for a novel two-piece button to replace the standard fixed buttons on apparel and clothing which allows the wearer to apply his own design or indicia to the button.

### SUMMARY OF THE INVENTION

A two-piece button having a backing member and a front member, the front member and back member securable by a securing means extending through alignable apparel button holes to secure a piece of apparel, the front member of the two piece button capable of receiving a unique design and/or indicia on its front face.

### BRIEF DESCRIPTION OF THE DRAWINGS

These and other objects of the present invention will become apparent, particularly when taken in light of the following illustrations wherein:

FIG. 1 is a perspective exploded view of a first embodiment of the button of the present invention;

FIG. 2 is a perspective exploded view of a second embodiment of the button of the present invention;

FIG. 3 is a side secured view of the button of the first embodiment;

FIG. 4 is an exploded view of a button of the first embodiment securing a waistband of a pair of trousers;

FIG. 5 is a side view of a button assembly of the first embodiment securing a pair of trousers; and

FIG. 6 is a partial front view of a shirt or jacket illustrating the removal of the fixed secured buttons, and the positioning of aligned button holes for use with the button assembly of the first or second embodiment.

### DETAILED DESCRIPTION OF THE INVENTION

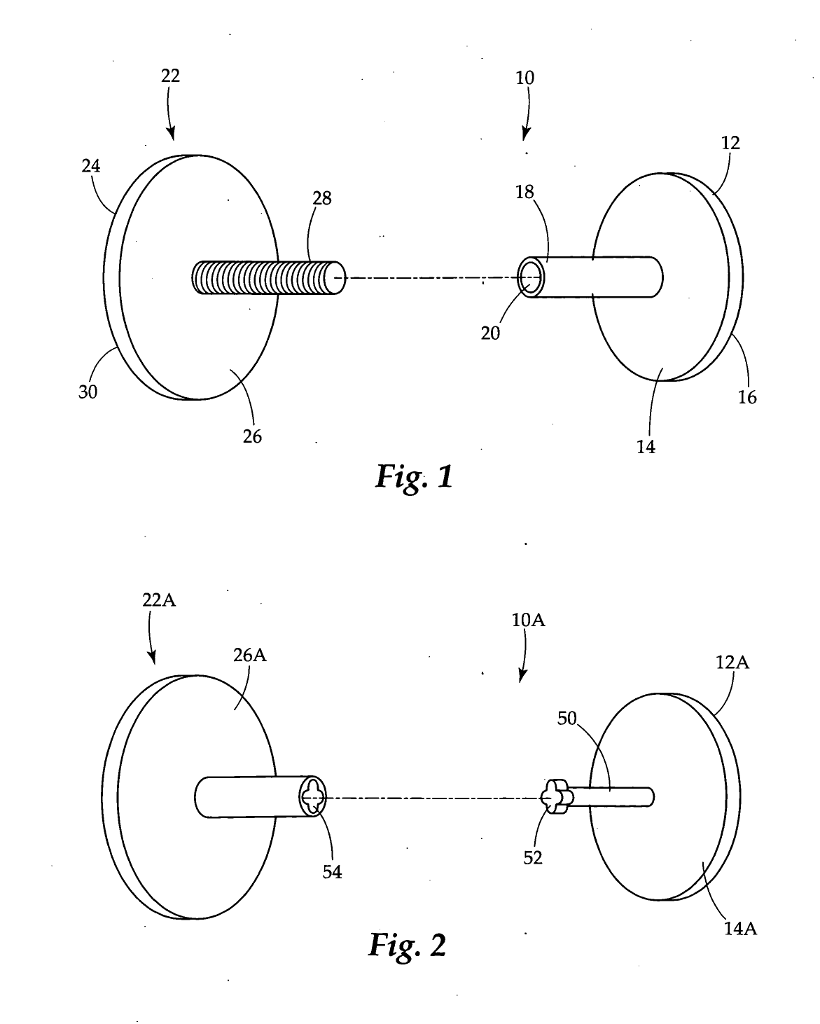

FIG. 1 is a perspective exploded view of a first embodiment of the button assembly 10 of the present invention. The button assembly 10 in its simplest form is of two-piece construction having a backing member 12 in the form of a circular disk having a front face 14 and a rear face 16. Front face 16 is formed with a unitary centralized cylindrical protrusion 18 having a threaded bore 20.

Front member 22 as illustrated in FIG. 1 is disk-shaped having a front face 24 and a rear face 26, rear face 26 being formed with a unitary centrally disposed perpendicular shaft 28 which is externally threaded to be received in the threaded bore 20 of backing member 12. The front face 24 of front member 22 may be planar or formed with a peripheral lip 30. Centrally disposed on the front face 24 of front member 22 would be a design, indicia, or logo. This design, indicia, or logo could be permanently affixed on front face 24 or could be removable such as a decal which would allow the wearer to choose the design or change the design as he/she desires.

In actual use, as illustrated in FIG. 4, the left and right hand side button holes 40 and 42 of a pair of jeans 44 are aligned, and the backing member 12 is positioned on the interior of the jeans overlap with the threaded bore 20 in alignment with the aligned button holes 40 and 42. The threaded shaft 28 of the front member 22 is then extended through the aligned button holes 40 and 42 and threadedly secured to the threaded bore 20 of the backing member 12. The size of the backing member 12, and in particular, its planar disk and the size of the planar disk of the front member 22 are sized such that they cover the button holes 40 and 42 and cannot pass there through.

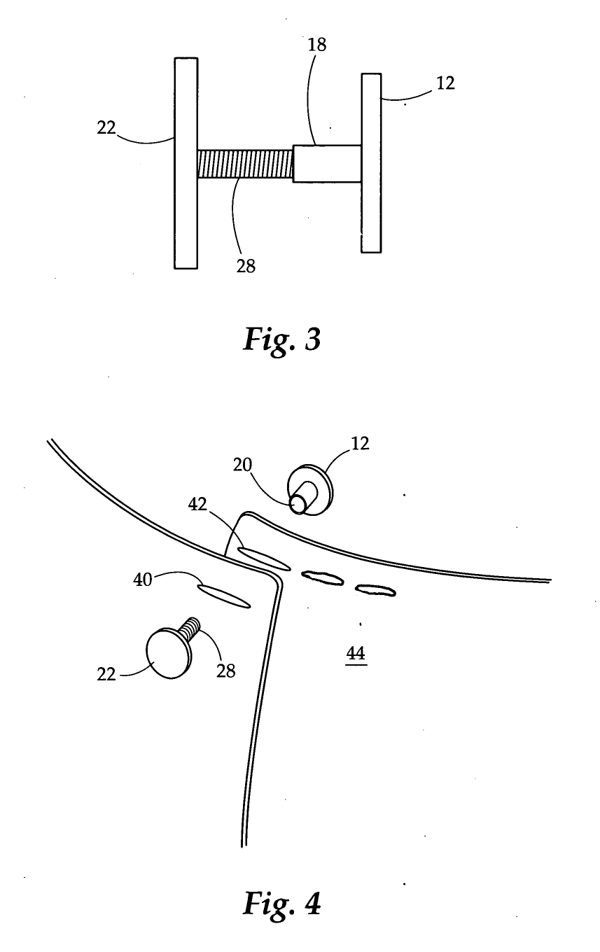

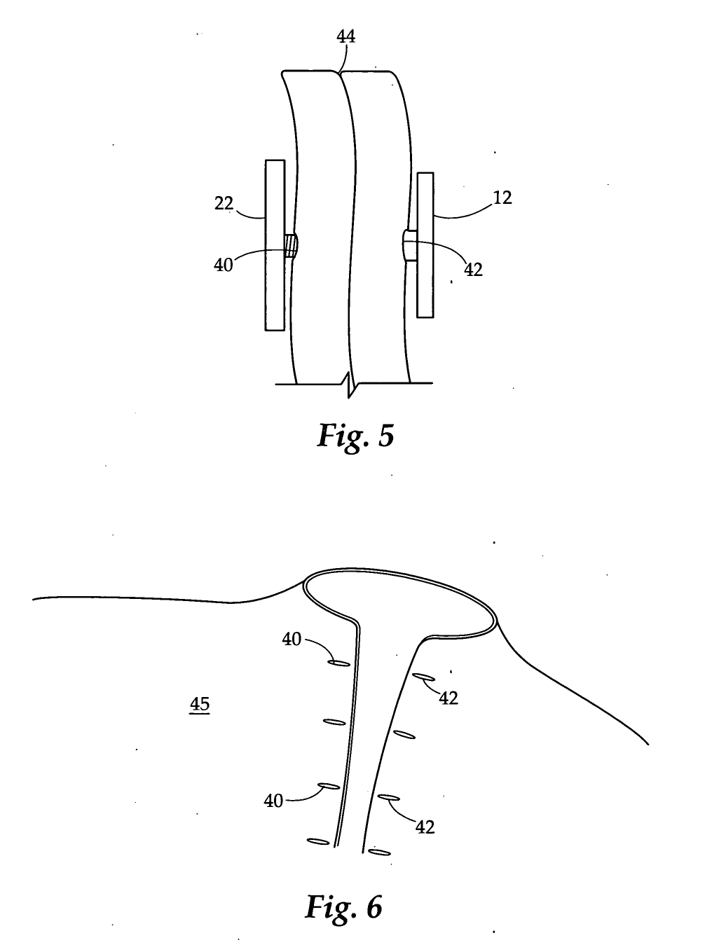

FIG. 5 illustrates FIG. 4 in a closure orientation with the jeans, while FIG. 3 illustrates the closure of the button assembly alone.

It will be recognized that the location of the threaded bore 20 and the threaded shaft 28 can be reversed without departing from the spirit and scope of the invention. That is the threaded bore 20 may be formed on the rear face 26 of the front member 22 and the threaded shaft 28 may be unitarily formed on the front face 14 of the backing member 12 without departing from the spirit and scope of the invention.

FIG. 2 is a perspective exploded view of a second embodiment of the button assembly 10A of the present invention illustrating an alternative method of securing the backing member 12A with the front member 22A. In this embodiment, the front face 14 of the backing member 12A has a unitarily formed centrally disposed shaft 50 which terminates in a bayonet mount type locking member 52. The rear face 26A of the front member 22A is unitarily formed with a bayonet locking receptacle 54. The backing member 12A and the front member 22A would be positioned in the manner previously described with respect to aligned button holes 40 and 42. Bayonet mount locking member 52 would be inserted through the aligned button holes and engage the bayonet locking receptacle 54 on the rear face 26A of the front member 22A. The front member 22A would then be given a twist to lock the bayonet members together securing the button in place. A reverse twist of the front member 22A would disengage the bayonet locking members and allow them to be removed.

Again, with respect to the second embodiment, the positioning of the bayonet receptacle and the bayonet locking member may be reversed with respect to the backing member and the front member.

The present invention has been disclosed with respect to a backing member and a front member which are geometrically in the shape of a circular disk. It should be understood by one of ordinary skill in the art that the shape of the backing member and the front member may vary and take on different geometric shapes, the only consideration being that the size of the backing member and the front member are such that they will not pass through the aligned button holes through which they are secured. It will also be recognized by those of ordinary skill in the art that while the invention has been disclosed with respect to two embodiments of securing the backing member and the front member in disengageable contact, other means of securing the front member and the backing member can be devised.

The button assembly of the present invention is designed to be used with a unique design of apparel in which the fixed secured buttons normally associated therewith are removed. The position where the fixed secured button would normally be positioned is replaced with a second button hole 42 as illustrated in FIG. 4 with respect to the pair of jeans 44, and is illustrated in FIG. 6 with respect to a shirt or jacket 45 having a buttoned opened front. The second button hole 42 would be alignable with the normal button hole 40 so that the apparel or garment was worn and fit normally. This allows the wearer to utilize the two piece button assembly of the present invention to make a fashion statement by mixing and matching buttons of various sizes, geometric shapes, and design or indicia. It should be noted that while the apparel illustrated in FIGS. 4 and 6 are illustrative of jeans and shirts or jackets, that other apparel which would normally utilize a fixed secured button, could be fabricated and cut to eliminate the fixed secured button, and provide the second button hole 42 as illustrated in FIGS. 4 and 6 and multiple adjustable button holes 42 as illustrated in FIG. 4.

Therefore, while the present invention has been disclosed with respect to the preferred embodiments thereof, it will be recognized by those of ordinary skill in the art that various changes and modifications can be made without departing from the spirit and scope of the invention. It is therefore manifestly intended that the invention be limited only by the claims and the equivalence thereof.

I claim:

1. A decorative button assembly comprising:
a backing member having a front face and a rear face, said front face having a securing member extending there from, said disk member dimensioned to have a diameter greater than the diameter of a buttonhole to which it is juxtaposed with said securing member extending there through;
a front member having a front surface and a rear surface, said rear surface having a securing member extending there from cooperable with said securing member of said backing member, said front member comprising a disk dimensioned to have a diameter greater than said buttonhole to which it is juxtaposed, said front face of said front member for the selective receipt of a design.

2. The decorative button assembly in accordance with claim 1 wherein said cylindrical securing means extending from said front face of said backing member comprises an interior threaded cylindrical bore.

3. The decorative button assembly in accordance with claim 1 wherein said securing means extending from said rear face of said front member comprises an exteriorly threaded cylinder cooperable with said interior threaded cylindrical bore of said securing member of said backing member.

4. The decorative button assembly in accordance with claim 1 wherein said securing member or said backing member and said front member comprises a complimentary two-piece bayonet mount extending from said front face of said backing member and said rear face of said front member.

5. The decorative button assembly in accordance with claim 1 wherein said front member and said back member are formed with a geometric shaped periphery.

6. The decorative button assembly in accordance with claim 1 wherein said front face of said front member is sized to allow the user to apply a unique design or indicia thereto and to selectively remove and replace said design or indicia.

7. The decorative button assembly in accordance with claim 6 wherein the unique design or indicia on said front face of said front member includes removable decals or removable paint.
